(19) United States
(12) Patent Application Publication
(10) Pub. No.: US 2005/0151445 A1
(43) Pub. Date: Jul. 14, 2005

(54) Piezoelectric actuator unit

(75) Inventors: Jens Titschert, Lunen (DE); Sebastian M. Mundry, Ludinghausen (DE); Horst Wagner, Edling (DE); Franz-Heinrich Suilmann, Werne (DE)

Correspondence Address: Alan C. Brandt, Esq.;Fay, Sharpe, Fagan, Minnich & McKee, LLP, Seventh Floor, 1100 Superior Avenue, Cleveland, OH, 44114-2518, US

(73) Assignee: DBT Automation GmbH

(21) Appl. No.: 11/032,813

(22) Filed: Jan. 10, 2005

(30) Foreign Application Priority Data
Jan. 14, 2004 (DE) 10 2004 002 111.2

(51) Int. Cl. H02N 2/00

(52) U.S. Cl. 310/316.03

(57) ABSTRACT

A piezoelectric actuator unit 10 for valve switching has a piezoelectric element changing its size on the application of a control voltage for switching the valve. So as to ensure a Totmann (safety) function of the valve and a fast return of the piezoelectric element into its initial position, the piezoelectric actuator unit 10 comprises a discharge circuit with at least one discharge element 21, 31 connected to the piezoelectric element 11. Discharge of the piezoelectric element is effected when the actuator is in its initial, safe position. The discharge circuit has to be switched actively so as to be able to exert a maximum stroke with the piezoelectric actuator.

The invention relates to a piezoelectric actuator unit for valve switching, in particular but not exclusively for use in mining for switching pilot valves for oil or water hydraulics in underground mining, with a piezoelectric element changing its size on application of a control voltage for switching the valve.

In underground mining, electromagnetic actuators consisting of pilot valves and main control valves are usually used in underground mine roof supports for switching the valves. The current requirement of the electromagnetic actuators can be limited with suitable circuits at the electromagnetic actuators, in particular with a circuit for reduction of the holding current. A limited current intake of each individual electromagnetic actuator enables a favourable ratio between installed electrical power and the valves being driven with the installed power in underground mining. All electromagnetic actuators used in underground mining are provided with a reset spring which ensures, for example with circuit errors, or with a short-term voltage drop in the power network, or with a cable break caused by a fault and in other situations that the pilot valve and the main control valve connected downstream return to their initial position. With the valves for driving the plungers of the underground mine roof supports, the initial position mostly corresponds to the closed position of the valve, so that the hydraulic or support jack of the mine roof support keep their current extension length or moving drives stay still. In underground mining, the automatic return of the electromagnetic actuators into their initial position is often referred to as a “Totmann function” or a “Totmann position”, which is demanded in a compelling manner with actuators or the valves switched therewith due to safety reasons, in underground mining.

In underground mining, furthermore significant attempts are made to reduce the electric power input of the actuators for switching the valves. An approach for this comprises the use of piezoelectric actuators, as these use the charging current for the capacity of the piezoelectric element only during the application of a control voltage and afterwards keep their switching state, that is their volume and length change while using a negligible residual current. Piezoelectric elements are distinguished by freedom from wear, fast switching times, and a high retaining strength at the beginning of the switching process, as well as a very low use of energy. Admittedly, piezoelectric elements only show small volume changes during the application of the control voltage, so that the maximum stroke necessary for switching the valves is as a rule only achieved by interposition of a mechanical lever device (DE 102 33 316 A1). DE 102 33 316 A1 discloses a possibility of a solution for a fast return of the switching lever with the “Totmann” function of the actuator, by assigning a hydraulically loadable piston to the operating lever.

Piezoelectric actuators distinguish themselves in particular by their capacitive behaviour. If a voltage is applied to a piezoelectric element, a load flux results on the piezoelectric element which holds this charge until it is discharged. An automatic discharge only takes place in a negligible manner by means of a leakage current via the internal resistance of the piezoelectric element. A short, automatic return of the piezoelectric element into its initial position by removing the control voltage is therefore not possible.

It is the object of the invention to create a piezoelectric actuator unit for mining which enables a safe and fast return into the initial position or initial extension of the piezoelectric element for the Totmann (deadman, safety) function.

A piezoelectric actuator unit according to the invention comprises a discharge circuit with at least one discharge element connected to the piezoelectric element. The discharge circuit is constructed in such a manner that the discharge element discharges the piezoelectric element permanently or constantly, as long as no signal opens actively the discharge circuit. The active opening of the discharge circuit for interrupting the discharge process preferably takes place by applying the control voltage and/or an unblocking voltage. The discharge circuit with the discharge element is consequently constructed in such a manner that the piezoelectric element is passively discharged with the discharge element, as long as no control signal is applied to the actuator unit or no control voltage is applied to the piezoelectric element or the discharge circuit activating the maximum stroke. Only when a control signal or a control voltage is applied to the piezoelectric element of the piezoelectric actuator unit by a superposed control unit, then the discharge element is driven by means of the discharge circuit in such a manner that the discharge element is separated from the piezoelectric element, whereby the discharge process is interrupted and the piezoelectric element can now execute the desired maximum stroke. The actuator for this is a suitable unblocking signal fed to the discharge circuit.

With the drivable discharge circuit comprising the discharge element provided according to the invention a discharge of the piezoelectric element is effected consequently for realising the Totmann function required for the mining operation if the actuator is to be in the safe mining initial position. The passive discharge of the piezoelectric element is accelerated considerably by the discharge element compared to an automatic discharge under a load, whereby a discharge of the piezoelectric element in principle effects a volume change of the piezoelectric element and thereby its return into the initial position.

In one embodiment according to the invention, the unblocking voltage can be generated immediately by the control voltage or from the control voltage. Alternatively, the unblocking voltage can be generated via a voltage reduction from the control voltage. During voltage interruption at the actuator unit, the unblocking voltage also collapses immediately. The unblocking signal can nevertheless be activated independently from the control signal, even if it is advantageous to activate the unblocking signal in particular immediately through the control signal. Furthermore, an analogue circuit can be provided for generating the control voltage and the unblocking voltage from a switching signal. Alternatively or additionally, an upstream, in particular digital processor for generating the control voltage and the unblocking voltage or the corresponding signals can be provided. This enables furthermore to exchange data, in particular nominal values, actual values and statuses with the upstream processor by means of a communication line with superposed control devices.

The invention also provides as an alternative to drive the discharge element by applying the same control voltage. It is clear that, by applying the same control voltage, that it does not necessarily have to be stipulated that the same control voltage for loading the piezoelectric element and for driving the discharge circuit is used. It is in fact sufficient for the invention that the drive of the discharge element or the discharge circuit is actuated by applying the control voltage to the actuator unit.

In the preferred embodiment, a switching element is assigned to the discharge circuit, which element interrupts a discharge of the piezoelectric element only during application of the control voltage or the unblocking voltage or separates a circuit with the discharge element, while it bypasses the piezoelectric element and the discharge element whenever no unblocking or control voltage is applied to the actuator unit. The preferred embodiment has the advantage that the piezoelectric element has to be unblocked actively for achieving the maximum stroke, as otherwise the piezoelectric element is discharged permanently and cannot be switched for this reason. In the case of a voltage interruption or another disturbance in the grid or in the superposed control device, a passive safety function is then permanently integrated into the piezoelectric actuator unit, which causes an automatic return of the piezoelectric element into its initial position.

In the particularly preferred embodiment, the discharge element is arranged parallel to the piezoelectric element. In the simplest embodiment of the discharge circuit, the discharge element consists of at least one discharge resistor. It is clear that the discharge resistor or the discharge resistors is/are adjusted to the capacity of the piezoelectric element. By a corresponding choice of the discharge resistor it is possible to discharge the piezoelectric element (the piezoelectric means or the piezoelectric actuator) within milliseconds.

The switching element can in particular consist of a switching transistor or a FET (field effect transistor), as in particular a NC-FET unit (NC=Normally Closed). Instead of a single switching transistor or FET, several switching transistors or FET units can be provided.

For the use of piezoelectric actuator units in underground mining, it is particularly advantageous if the discharge circuit is executed in a redundant manner and comprises at least two circuits with discharge element and switching element. The redundant execution of the discharge circuit with several circuits ensures the functioning of the Totmann function even during occurrence of a break of the contact between one of the discharge circuits and the piezoelectric element. As the piezoelectric element changes its volume as a matter of principle, a reliable contact of the piezoelectric element with a circuit presents a problem; after a plurality of maximum strokes, a break of individual contacts can result. In the preferred embodiment according to the invention, every circuit is therefore connected to the piezoelectric element by means of a separate contact. For the same reasons, it is particularly advantageous if some or all electrical contacts with the piezoelectric element are at least executed in a twofold manner.

It will be obvious to the expert, that, in the piezoelectric actuator unit, all types of piezoelectric elements can be used, in particular piezoelectric element stacks, as the discharge circuit according to the invention can be provided independently from the embodiment of the piezoelectric element.

Further advantages and embodiments of the invention result from the following description of an example of an embodiment for an underground hydraulic valve with piezoelectric actuator unit shown schematically in the figures, in which:

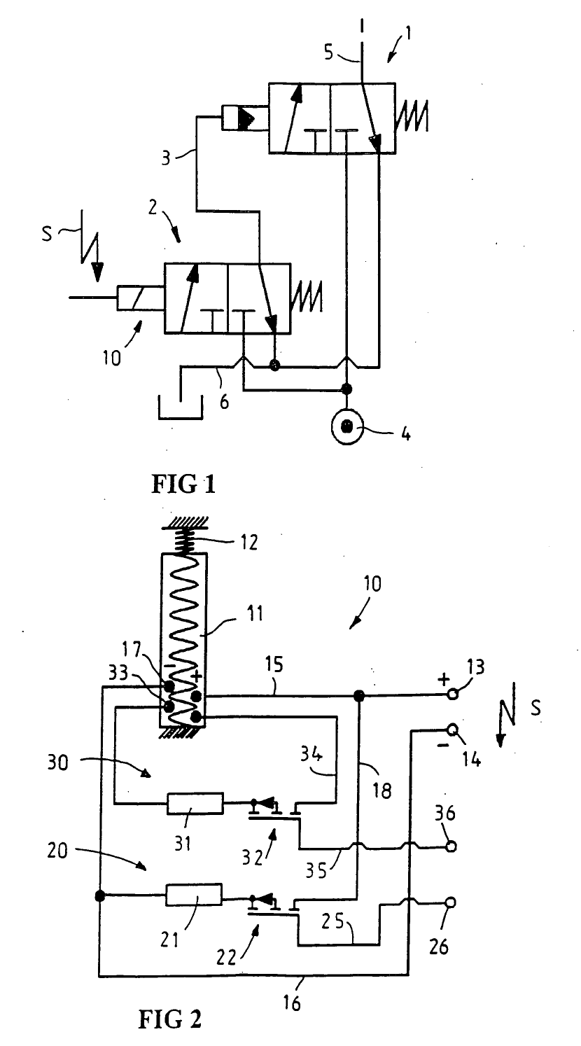

FIG. 1 is an hydraulic circuit diagram, a hydraulic pilot valve having a piezoelectric actuator unit, for underground mining, in its initial (Totmann) position;

FIG. 2 is an electric circuit diagram of the design of a discharge circuit of a piezoelectric actuator unit according to the invention; and

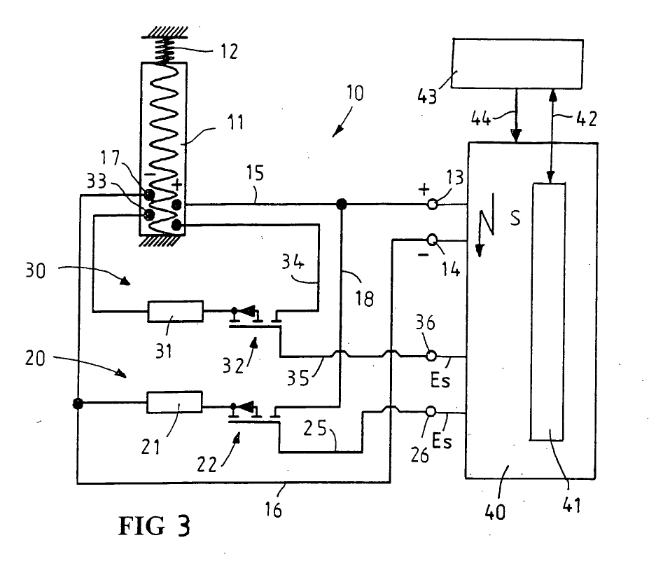

FIG. 3 is a similar circuit diagram a second piezoelectric actuator unit according to the invention.

In the circuit diagram of FIG. 1, a pilot valve 2 is coupled to a hydraulic control valve 1. The pilot valve can be actuated by applying a symbolically indicated control voltage S to a piezoelectric actuator unit 10. The circuit diagram shows the two valves 1, 2 in their initial position. By powering the piezoelectric actuator unit 10, the valve slide of the pilot valve is displaced in such a manner that the exit line 3 of the pilot valve 2 is connected hydraulically to the high pressure source 4, whereby the valve slide of the main control valve 1 also changes its position and connects a jack connected by means of the jack line 5 to the high pressure source 4. Whereas, in the initial position shown, the jack line 5 and the exit line 3 of the pilot valve 2 are connected to the return run.

In the known design of hydraulic valves for underground mining with an electromagnetic actuator, the switching rod of the electromagnet would then always again be moved back into its initial position by means of a spring, if there is no control voltage at the actuator, that is, no current flows through the coil of the electromagnet. Whereas, with the electrical actuator unit 10 for driving the pilot valves 2 according to the invention, a discharge circuit is provided, so as to move the piezoelectric element of the piezoelectric actuator unit 10 back into its initial position when no control voltage S is applied to the actuator unit 10.

FIG. 2 shows the piezoelectric actuator unit 10 with the piezoelectric element 11 in an electrical schematic diagram. The piezoelectric element 11 is prestressed in its initial position by means of the symbolically shown prestress spring 12. However, the spring force of the prestress spring 12 is not sufficient for a fast electrical automatic discharge of the piezoelectric element 1. As known per se, the piezoelectric element 11 is extended in its length by applying a control voltage S to the drive poles 13, 14 of the piezoelectric actuator unit 10 for effecting a maximum stroke. Both drive poles 13, 14 are connected to the piezoelectric element 11 by means of lines 15, 16, and the system of drive poles 13, 14 as well as lines 15, 16 forms the piezoelectric drive for the piezoelectric element. In accordance with the invention, the piezoelectric actuator unit 10 is now provided with a discharge circuit which comprises two identically constructed discharge circuits 20, 30 in the example of the embodiment according to FIG. 2. Each discharge circuit 20, 30 consists of a discharge resistor 21, 31 and a FET unit 22, 32 connected to it. Both discharge resistors 21, 31 are switched in a parallel manner to the piezoelectric element 11, and, in the shown example of the embodiment, the discharge resistor 21 has the same contact 17 at the piezoelectric element 11 as the negative pole line 16 of the piezoelectric drive, while the discharge resistor 31 is connected to the piezoelectric element 11 by means of a separate contact 33. In this connection, it is not shown that each contact could at the same time be made in a multiple manner. The FET units 22, 23 assigned to the discharge resistors 21, 31 are implemented in such a manner that they normally bypass the piezoelectric element 11 with the respectively assigned discharge resistor 21 or 31 via the lines, whereby the discharge resistors 21, 31 discharge the piezoelectric element. However, if the control voltage S is applied to the drive poles 13, 14 and also to the drive poles 26, 36, the FET unit 22 is loaded with the control voltage S by means of the branch line 18, 25, and the FET unit 32 by means of the contact line 34, 35, so that both FET units open and interrupt the respective discharge circuits 20, 30 or open then as well. Only when the control voltage S is applied to the drive poles 13, 14 as well as 26, 36, then consequently no active discharge of the piezoelectric element 11 takes place by means of the discharge resistors 21, 31. As soon as the control voltage S at the drive poles 13, 14 of the piezoelectric activation and at the drive poles 26, 36 drops out, the FET units 22, 32 close and thereby short-circuits the discharge resistors 21, 31 with the piezoelectric element, so that the discharge of the piezoelectric element 11 starts again immediately. Thus, the piezoelectric element 11 again takes up its initial length, whereby the pilot valve (2, FIG. 1) returns into its initial position.

FIG. 3 shows, as a second embodiment of the invention, the piezoelectric actuator unit 10 in a drive with an upstream control 40. The piezoelectric actuator unit 10 has the same construction as in the example of the embodiment of FIG. 2, and same units are provided with the same reference numerals. The previous description can be referred to. The analogue circuit 40 generates the control voltage S on the one hand from a drive signal 44 of a superposed control device 43, and also an unblocking voltage Es on the other hand. Despite the control voltage S at the drive poles 13, 14 the piezoelectric element 11 is only extended when an unblocking signal, for example as unblocking voltage Es, is applied at the same time at the drive poles 26, 36; because the discharge circuits 20, 30 are only opened through the unblocking voltage Es, which drives the FET units 22, 32 via the drive lines 25, 35. This active opening of the discharge circuits 20, 30, whereby the discharge resistors 21,31 are separated from the piezoelectric element, is a mandatory condition for a length extension of the piezoelectric element 11. Only when the unblocking voltage Es is applied to the drive poles 26, 36, then consequently no otherwise continuous discharge of the piezoelectric element 11 takes place via the discharge resistors 21, 31. As soon as the unblocking voltage Es drops at the drive poles 26, 36, the FET units 22, 32 close and thereby shorts the discharge resistors 21, 31 with the piezoelectric element again, so that the discharge of the piezoelectric element starts again immediately. Hereby, the piezoelectric element 11 takes its initial length again, whereby the pilot valve (2, FIG. 1) returns to its initial position. The circuit 40 can have a processor (CPU etc.) 41, shown schematically, so as to exchange data such as nominal and actual values via the communication line 44 with the superposed control device in a bidirectional manner.

For the expert, numerous modifications can be seen in the preceding description, which shall fall within the scope of protection of the appended claims. Instead of just one discharge circuit or two discharge circuits, three or more discharge circuits could be used. Some or all of the contacts could be duplicated or further multiplied. Instead of FET units, which are opened by applying a control voltage, other suitable switching transistors could also be used.

1-19. (canceled)

20. A piezoelectric actuator unit for valve switching, the unit comprising:
a piezoelectric element adapted to change its size for valve switching when a control voltage is applied and
a discharge circuit connected to the piezoelectric element,
the circuit comprising at least one discharge element for discharging the piezoelectric element, and
the circuit be adapted to be opened by applying the control voltage for activating the piezoelectric unit.

21. The piezoelectric actuator unit as claimed in claim 20, wherein the discharge circuit comprises a switching element which interrupts the discharge of the piezoelectric element only with an applied control voltage.

22. The piezoelectric actuator unit as claimed in claim 21, wherein the switching element consists of or comprises a switching transistor.

23. The piezoelectric actuator unit as claimed in claim 21, wherein the switching element consists of or comprises an FET unit.

24. The piezoelectric actuator unit as claimed in claim 20, wherein the discharge circuit with the discharge element is arranged parallel to the piezoelectric element.

25. The piezoelectric actuator unit as claimed in claim 20, wherein the discharge element consists of at least one discharge resistor.

26. The piezoelectric actuator unit as claimed in claim 20, wherein the discharge circuit is executed in a redundant manner and comprises at least two discharge circuits with discharge elements and switching elements.

27. The piezoelectric actuator unit as claimed in claim 26, wherein each discharge circuit is connected to the piezoelectric element by means of a separate contact.

28. The piezoelectric actuator unit as claimed in claim 20, wherein all electrical contacts with the piezoelectric element are duplicated or further multiplied.

29. A piezoelectric actuator unit for valve switching, the unit comprising:
a piezoelectric element adapted to change its size for valve switching when a control voltage is applied and
a discharge circuit connected to the piezoelectric element,
the circuit comprising at least one discharge element for discharging the piezoelectric element, and
the circuit be adapted to be opened by applying an unblocking voltage for interrupting a discharge process.

30. The piezoelectric actuator unit as claimed in claim 29, wherein the discharge circuit comprises a switching element which interrupts the discharge of the piezoelectric element only with an applied unblocking voltage.

31. The piezoelectric actuator unit as claimed in claim 30, wherein the discharge circuit is adapted to generate the unblocking voltage by application of the control voltage or to generate the unblocking voltage from the control voltage or to generate the unblocking voltage via a voltage reduction.

32. The piezoelectric actuator unit as claimed in claim 30, wherein the switching element consists of or comprises a switching transistor.

33. The piezoelectric actuator unit as claimed in claim 30, wherein the switching element consists of or comprises an FET unit.

34. The piezoelectric actuator unit as claimed in claim 29, wherein the discharge circuit is adapted to generate the unblocking voltage by application of the control voltage or to generate the unblocking voltage from the control voltage or to generate the unblocking voltage via a voltage reduction.

35. The piezoelectric actuator unit as claimed in claim 29, wherein the discharge circuit is adapted to cause the unblocking voltage to collapse immediately on voltage interruption at the actuator unit.

36. The piezoelectric actuator unit as claimed in claim 29, wherein the unit includes an analogue circuit for generating the control voltage and the unblocking voltage from a switching signal.

37. The piezoelectric actuator unit as claimed in claim 29, wherein the unit includes digital processor, connected upstream in series, for generating the control voltage and the unblocking voltage.

38. The piezoelectric actuator unit as claimed in claim 37, wherein the upstream processor is adapted to exchange data, in particular nominal values, actual values, and statuses by means of a communication line with superposed control devices.

39. The piezoelectric actuator unit as claimed in claim 29, wherein the discharge circuit with the discharge element is arranged parallel to the piezoelectric element.

40. The piezoelectric actuator unit as claimed in claim 29, wherein the discharge element consists of at least one discharge resistor.

41. The piezoelectric actuator unit as claimed in claim 29, wherein the discharge circuit is executed in a redundant manner and comprises at least two discharge circuits with discharge elements and switching elements.

42. The piezoelectric actuator unit as claimed in claim 41, wherein each discharge circuit is connected to the piezoelectric element by means of a separate contact.

43. The piezoelectric actuator unit as claimed in claim 29, wherein all electrical contacts with the piezoelectric element are duplicated or further multiplied.

44. A piezoelectric actuator unit for valve switching, the unit comprising:
a piezoelectric element adapted to change its size for valve switching when a control voltage is applied; and
a discharge circuit connected to the piezoelectric element, the circuit comprising:
at least one discharge element for discharging the piezoelectric element;
wherein the discharge circuit is adapted to be opened by applying the control voltage for activating the piezoelectric unit or by applying an unblocking voltage for interrupting a discharge process.
